(19) United States
(12) Patent Application Publication
(10) Pub. No.: US 2014/0266968 A1
(43) Pub. Date: Sep. 18, 2014

(54) COMMUNICATION DEVICE AND ANTENNA ELEMENT THEREIN

(71) Applicant: ACER INCORPORATED, New Taipei City (TW)

(72) Inventors: Kin-Lu WONG, New Taipei City (TW); Meng-Ting CHEN, New Taipei City (TW)

(73) Assignee: ACER INCORPORATED, New Taipei City (TW)

(21) Appl. No.: 13/795,627

(22) Filed: Mar. 12, 2013

(51) Int. Cl. H01Q 1/50

(52) U.S. Cl. CPC H01Q 1/50
USPC 343/876

(57) ABSTRACT

A communication device including a ground element and an antenna element is provided. The antenna element includes a first portion and a second portion. The first portion has a first end and a second end. The first end is used as a first feeding point of the antenna element. The second portion has a third end and a fourth end. The third end is used as a second feeding point of the antenna element, and the fourth end is open. A first switch is coupled between the second end of the first portion and the third end of the second portion. The first switch is further coupled through the first portion and a first reactive circuit to a communication module. A second switch is coupled to the third end of the second portion. The second switch is further coupled through a second reactive circuit to the communication module.

### BACKGROUND OF THE INVENTION

1. Field of the Invention

The disclosure generally relates to a communication device, and more particularly, relates to a communication device comprising a reconfigurable dual-feed ground plane antenna element.

2. Description of the Related Art

With fast development in the wireless communication industry, functions of mobile communication devices have become more progressive in order to meet a variety of user requirements. Generally, mobile communication devices should be thin, but must also include many components. It is a critical challenge for antenna designers to design antenna elements with more functions and improved performance, with smaller available space in mobile communication devices.

Accordingly, there is a need to design a novel mobile communication device comprising a small antenna to solve the problem of very limited space for accommodating antenna elements.

### BRIEF SUMMARY OF THE INVENTION

The invention is aimed to provide a communication device and a reconfigurable dual-feed ground plane antenna element therein. The ground plane antenna element mainly comprises an antenna element and a ground element in the communication device. The antenna element comprises a first portion and a second portion. A switch is disposed between the first portion and the second portion such that the antenna element can have a combination of different resonant current paths. The switch is further configured to control the antenna element to excite a plurality of different resonant modes. Accordingly, the antenna element is capable of operating in the multiple bands. The total length of the first portion and the second portion is smaller than 0.15 wavelength of the lowest frequency of the operating bands of the antenna element. In other words, the total length of the antenna element of the invention is much smaller than the 0.25 wavelength required by a conventional antenna element, thereby allowing the antenna size to be decreased.

In a preferred embodiment, the invention provides a communication device, comprising: a ground element; and an antenna element, disposed adjacent to the ground element, and not overlapping with the ground element, wherein the antenna element comprises: a first portion, having a first end and a second end, wherein the first end is used as a first feeding point of the antenna element; and a second portion, having a third end and a fourth end, wherein the third end is used as a second feeding point of the antenna element, and the fourth end is open. A first switch is coupled between the second end of the first portion and the third end of the second portion, and the first switch is further coupled through the first portion and a first reactive circuit to a communication module. A second switch is coupled to the third end of the second portion, and the second switch is further coupled through a second reactive circuit to the communication module.

In some embodiments, the antenna element substantially extends along a first edge of the ground element or along two adjacent edges of the ground element. In some embodiments, the antenna element is adjacent to a corner of the ground element. The second portion substantially extends along a first edge of the ground element, and the first portion substantially extends along a second edge of the ground element. The first edge is adjacent and perpendicular to the second edge.

In some embodiments, when the first switch is closed and the second switch is open, the antenna element receives input energy through the first feeding point and operates in a first band. In some embodiments, when the second switch is closed and the first switch is open, the antenna element receives input energy through the second feeding point and operates in a second band. In some embodiments, the first band is approximately from 704 MHz to 960 MHz, and the second band is approximately from 1710 MHz to 2690 MHz.

In some embodiments, the first portion of the antenna element substantially has an L-shape or a straight-line shape. In some embodiments, the second portion of the antenna element substantially has an L-shape or a straight-line shape.

In the invention, the antenna element and the ground element form an asymmetry dipole antenna structure. The different feeding points of the antenna element are selectively coupled to a signal source by controlling the switches. The antenna element can use a combination of the first portion and the second portion or only the second portion to obtain different resonant current paths. The antenna element can further control the different resonant modes to be excited. More particularly, the antenna element can operate in multiple bands as follows. When the first switch is closed and the second switch is open, the antenna element resonates by using the combination of the first portion and the second portion. In addition, the first reactive circuit provides a first impedance value such that the antenna element resonates in the first band. The total length of the first portion and the second portion is smaller than 0.15 wavelength of the lowest frequency of the first band. In this case, the antenna element generates a resonant mode to cover a lower band thereof. When the second switch is closed and the first switch is open, the antenna element resonates by using only the second portion. In addition, the second reactive circuit provides a second impedance value such that the antenna element resonates in the second band. The length of the second portion is smaller than 0.15 wavelength of the lowest frequency of the second band. In this case, the antenna element generates another resonant mode to cover a higher band thereof.

In some embodiments, the antenna element substantially has a planar structure and has a total area of about 300 mm² (10 mm by 30 mm). In some embodiments, the antenna element can switch between a lower band and a higher band. The lower band can cover LTE700/GSM850/900 bands, and the higher band can cover GSM1800/1900/UMTS/LTE2300/2500 bands. In other words, the antenna element can cover the first band which is approximately from 704 MHz to 960 MHz and the second band which is approximately from 1710 MHz to 2690 MHz to achieve LTE/WWAN (Long Term Evolution/Wireless Wide Area Network) multi-band operations.

### BRIEF DESCRIPTION OF DRAWINGS

The invention can be more fully understood by reading the subsequent detailed description and examples with references made to the accompanying drawings, wherein:

FIG. 1 is a diagram for illustrating a communication device according to a first embodiment of the invention;

FIG. 2 is a diagram for illustrating return loss of an antenna element receiving input energy through a first feeding point according to a first embodiment of the invention;

FIG. 3 is a diagram for illustrating return loss of an antenna element receiving input energy through a second feeding point according to a first embodiment of the invention;

FIG. 4 is a diagram for illustrating antenna efficiency of an antenna element receiving input energy through a first feeding point according to a first embodiment of the invention;

FIG. 5 is a diagram for illustrating antenna efficiency of an antenna element receiving input energy through a second feeding point according to a first embodiment of the invention;

FIG. 6 is a diagram for illustrating a communication device according to a second embodiment of the invention; and

FIG. 7 is a diagram for illustrating a communication device according to a third embodiment of the invention.

### DETAILED DESCRIPTION OF THE INVENTION

In order to illustrate the foregoing and other purposes, features and advantages of the invention, the embodiments and figures thereof in the invention are described in detail as follows.

FIG. 1 is a diagram for illustrating a communication device 100 according to a first embodiment of the invention. The communication device 100 may be a smart phone, a tablet computer, or a notebook computer. As shown in FIG. 1, the communication device 100 at least comprises a ground element 10 and an antenna element 11. The antenna element 11 substantially extends along a first edge 101 of the ground element 10. The ground element 10 may be a metal plane disposed on a dielectric substrate (not shown), such as an FR4 substrate or a system circuit board. The antenna element 11 is disposed adjacent to the ground element 10, and does not overlap with the ground element 10. The antenna element 11 comprises a first portion 12 and a second portion 13. In the embodiment, the first portion 12 substantially has an L-shape, and the second portion 13 substantially has a straight-line shape. However, the invention is not limited to the above. In other embodiments, any of the first portion 12 and the second portion 13 may substantially have a straight-line shape, an L-shape, a J-shape, a U-shape, a W-shape, or an S-shape. The first portion 12 has a first end 121 and a second end 122. The first end 121 is used as a first feeding point of the antenna element 11. The second portion 13 has a third end 131 and a fourth end 132. The third end 131 is used as a second feeding point of the antenna element 11, and the fourth end 132 is open. A first switch 14 is coupled between the second end 122 of the first portion 12 and the third end 131 of the second portion 13. The first switch 14 is further coupled through the first portion 12 and a first reactive circuit 16 to a communication module 18. A second switch 15 is coupled to the third end 131 of the second portion 13. The second switch 15 is further coupled through a second reactive circuit 17 to the communication module 18. The first reactive circuit 16 provides a first impedance value, and the second reactive circuit 17 provides a second impedance value. The first impedance value may be different from the second impedance value. In some embodiments, each of the first reactive circuit 16 and the second reactive circuit 17 comprises one or more inductors and capacitors, such as chip inductors and chip capacitors. The communication module 18 is considered as a signal source of the antenna element 11. By controlling the first switch 14 and the second switch 15, the antenna element 11 selects the first feeding point or the second feeding point to receive input energy from the signal source to operate in different bands. The types of the first switch 14 and the second switch 15 are not limitations of the invention. For example, each of the first switch 14 and the second switch 15 may be implemented using a PIN diode. In some embodiments, the communication device 100 further comprises a control unit (not shown). The control unit selectively closes and opens any of the first switch 14 and the second switch 15 according to a user input signal or a detection signal. In some embodiments, the communication device 100 further comprises a sensor (not shown). The sensor detects a frequency of an electromagnetic signal nearby and accordingly generates the detection signal. Note that the communication device 100 may further comprise other components, such as a touch panel, a processor, a speaker, a battery, and a housing (not shown).

FIG. 2 is a diagram for illustrating return loss of the antenna element 11 receiving input energy through the first feeding point (the first end 121 of the first portion 12) according to the first embodiment of the invention. In the embodiment, the total area of the ground element 10 is approximately equal to 15000 mm² (100 mm by 150 mm) which is consistent with a typical size of a ground element of a tablet computer, and the total area of the antenna element 11 is merely approximately equal to 300 mm² (10 mm by 30 mm) When the first switch 14 is closed and the second switch 15 is open, the antenna element 11 resonates by using a combination of the first portion 12 and the second portion 13 to form a first band 21. In a preferred embodiment, the first band 21 covers the LTE700/GSM850/900 bands (from about 704 MHz to about 960 MHz). In the embodiment, the total length of the first portion 12 and the second portion 13 is smaller than 0.15 wavelength of the lowest frequency in the first band 21.

FIG. 3 is a diagram for illustrating return loss of the antenna element 11 receiving input energy through the second feeding point (the third end 131 of the second portion 13) according to the first embodiment of the invention. When the second switch 15 is closed and the first switch 14 is open, the antenna element 11 resonates by using only the second portion 13 to form a second band 31. In a preferred embodiment, the second band 31 covers the GSM1800/1900/UMTS/LTE2300/2500 bands (from about 1710 MHz to about 2690 MHz). In the embodiment, the length of the second portion 13 is smaller than 0.15 wavelength of the lowest frequency in the second band 31.

FIG. 4 is a diagram for illustrating antenna efficiency of the antenna element 11 receiving input energy through the first feeding point according to the first embodiment of the invention. In the embodiment, the first switch 14 is closed and the second switch 15 is open. As shown in FIG. 4, the antenna efficiency curve 41 represents the antenna efficiency of the antenna element 11 operating in the LTE700/GSM850/900 bands. According to the results, it is understood that the antenna element 11 has good antenna efficiency (return losses included) in the LTE700/GSM850/900 bands and meets current application requirements.

FIG. 5 is a diagram for illustrating antenna efficiency of the antenna element 11 receiving input energy through the second feeding point according to the first embodiment of the invention. In the embodiment, the second switch 15 is closed and the first switch 14 is open. As shown in FIG. 5, the antenna efficiency curve 51 represents the antenna efficiency of the antenna element 11 operating in the GSM1800/1900/UMTS/LTE2300/2500 bands. According to the result, it is understood that the antenna element 11 has good antenna efficiency (return losses included) over GSM1800/1900/UMTS/LTE2300/2500 bands and meets current application requirements.

FIG. 6 is a diagram for illustrating a communication device 600 according to a second embodiment of the invention. In the second embodiment, an antenna element 61 is disposed adjacent to a corner of the ground element 10, and substantially extends along two adjacent edges of the ground element 10 to save the internal design space of the communication device 600. In the second embodiment, a first portion 62 of the antenna element 61 substantially has an L-shape, and a second portion 63 of the antenna element 61 also substantially has an L-shape. Other features of the second embodiment are similar to those of the first embodiment. Accordingly, the two embodiments can achieve similar performances.

FIG. 7 is a diagram for illustrating a communication device 700 according to a third embodiment of the invention. In the third embodiment, an antenna element 71 is disposed adjacent to a corner of the ground element 10. A second portion 73 of the antenna element 71 substantially extends along a first edge 101 of the ground element 10, and a first portion 72 of the antenna element 71 substantially extends along a second edge 102 of the ground element 10 to save the internal design space of the communication device 700. The first edge 101 is adjacent and perpendicular to the second edge 102. In the third embodiment, the first portion 72 of the antenna element 71 substantially has a straight-line shape, and the second portion 73 of the antenna element 61 also substantially has a straight-line shape. Other features of the third embodiment are similar to those of the first embodiment. Accordingly, the two embodiments can achieve similar performances.

Note that the above element sizes, element shapes, and frequency ranges are not limitations of the invention. An antenna designer can adjust these setting values according to different requirements.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a ground element; and
an antenna element, disposed adjacent to the ground element, and not overlapping with the ground element, wherein the antenna element comprises:
a first portion, having a first end and a second end, wherein the first end is used as a first feeding point of the antenna element; and
a second portion, having a third end and a fourth end, wherein the third end is used as a second feeding point of the antenna element, and the fourth end is open,
wherein a first switch is coupled between the second end of the first portion and the third end of the second portion, the first switch is further coupled through the first portion and a first reactive circuit to a communication module, a second switch is coupled to the third end of the second portion, and the second switch is further coupled through a second reactive circuit to the communication module.

2. The communication device as claimed in claim 1, wherein the antenna element substantially extends along a first edge of the ground element.

3. The communication device as claimed in claim 1, wherein the antenna element is disposed adjacent to a corner of the ground element, the second portion substantially extends along a first edge of the ground element, the first portion substantially extends along a second edge of the ground element, and the first edge is adjacent and perpendicular to the second edge.

4. The communication device as claimed in claim 1, wherein when the first switch is closed and the second switch is open, the antenna element receives input energy through the first feeding point and operates in a first band.

5. The communication device as claimed in claim 4, wherein when the second switch is closed and the first switch is open, the antenna element receives input energy through the second feeding point and operates in a second band.

6. The communication device as claimed in claim 5, wherein the first band is approximately from 704 MHz to 960 MHz, and the second band is approximately from 1710 MHz to 2690 MHz.

7. The communication device as claimed in claim 4, wherein the first reactive circuit provides a first impedance value such that the antenna element resonates in the first band, and a total length of the first portion and the second portion is smaller than 0.15 wavelength of the lowest frequency in the first band.

8. The communication device as claimed in claim 5, wherein the second reactive circuit provides a second impedance value such that the second portion resonates in the second band, and a length of the second portion is smaller than 0.15 wavelength of the lowest frequency in the second band.

9. The communication device as claimed in claim 1, wherein the first portion substantially has an L-shape or a straight-line shape.

10. The communication device as claimed in claim 1, wherein the second portion substantially has an L-shape or a straight-line shape.

11. The communication device as claimed in claim 1, wherein the antenna element substantially extends along two adjacent edges of the ground element.
